(19) United States
(12) Patent Application Publication
(10) Pub. No.: US 2024/0065806 A1
(43) Pub. Date: Feb. 29, 2024

(54) ELONGATED TAB MATRIX BAND

(71) Applicant: Adam DOUDNEY, Auckland (NZ)

(72) Inventor: Adam Doudney, Auckland (NZ)

(73) Assignee: Rhondium IP Limited, Katikati (NZ)

(21) Appl. No.: 18/271,006

(22) PCT Filed: Jan. 4, 2022
(86) PCT No.: PCT/US2022/011195

§ 371 Date: Jul. 5, 2023

(30) Foreign Application Priority Data
Jan. 5, 2021 (NZ) 771634

(51) Int. Cl. A61C 5/85; A61C 5/82

(52) U.S. Cl. CPC A61C 5/85; A61C 5/82

(57) ABSTRACT

A dental matrix band in sectional or circumferential configurations comprises at least a first elongated tab with a plurality of through holes and perforations on the undersurface to aid in positioning and bonding of the dental matrix band to a tooth or teeth adjacent the tooth being restored to improve the restoration procedure and results.

### FIELD OF THE INVENTION

This invention relates the placement of dental restorative material to a tooth undergoing a restoration with the use of dental matrix bands.

### BACKGROUND OF INVENTION

The placement of dental restorative material is a difficulty when trying to achieve the correct anatomical shape and function, especially between teeth where the dentist cannot access after the restorative material is placed and hardened. The biggest difficulty is not only getting the correct rounded shape but also making sure there is a good tight “contact” between teeth, so no food is trapped facilitating gum disease, bone loss, decay and patient discomfort.

Traditionally and currently a thin metal band called a dental matrix band is used to form the rounded shape as best it can, however due to the thickness of the metal it can leave a gap between teeth, hence another method as well as the matrix band is required to combat this problem which puts pressure between the teeth to separate the teeth more than the thickness of the metal while placing the filling material, so when the matrix and separating device is removed the net result is ideally a tight contact. Issues with traditional methodology include: (1) several devices are required in the mouth; (2) quite a lot of pressure is required to force the teeth apart which can cause discomfort, pinching of the gum, fracture of weak cusps that the pressure is placed on; (3) the rings used to force the teeth apart can be a danger if not applied properly and carefully as they can shoot off the tooth or applicators presenting a swallowing/inhaling danger; (4) when the rings are placed, they can distort the shape of the metal matrix making a less ideal shape of filling or opening up the base of the matrix and allowing an overhang to be made; (5) a good contact between teeth is still not guaranteed; (6) the method does not work well when making contacts on both sides of the tooth at once since the separating devices push against each other; and (7) unpredictable contact tightness (i.e., too tight or not tight enough) as there are several factors in play such as thickness of the matrix used, the size of the tooth and rigidity of the tooth to separate and the like.

The inventive dental matrix bands disclosed and described herein aims to address and overcome the issues and challenges noted with the traditional methods and devices described above. The object of this invention is to provide a matrix band that does not require special rings to cause separation to get good contacts, which allows a more predictable and more ideal shape of restoration.

### SUMMARY OF INVENTION

A dental matrix band comprises a band having a first and a second end, a top margin and a bottom margin, and an inner and an outer surface, and a first elongated tab extending from the top margin of the band, the first elongated tab having a proximal end at the top margin and extends to a distal end, the first elongated tab comprising a plurality of through holes. The plurality of through holes on the first elongated tab comprise a first hole at the distal end of the tab and at least a first retention hole at the proximal end of the tab. An underside of the first elongated tab includes a bonding surface, wherein the bonding surface comprises ridges, perforations, or a roughened surface. The plurality of through holes on the first elongated tab comprise a first and a second retention hole at the proximal end of the tab.

The first elongated tab comprises a first fold, the first fold dividing the first elongated tab into a first, proximal section and a second, distal section. The first, proximal section comprises at least a first retention hole. The first, proximal section and the second, distal section each comprise at least a first retention hole. The second, distal section comprises a first hole configured to receive a dental tool. The plurality of through holes are selected from the group comprising: retention holes, and a hole configured to receive a dental tool.

In one embodiment, the dental matrix band is a sectional matrix band, and the first elongated tab is at a mid-point on the top margin between the first and second ends of the band. In another embodiment, the dental matrix band is a circumferential band, and the first elongated tab and a second tab are spaced apart along the top margin of the band. In the sectional matrix band embodiment, the first and second tabs are spaced apart along the top margin of the band. The band forms a loop and the first and second tabs are at opposing points on the loop along the top margin of the band. The first and second tabs are adjacent along the top margin of the band. The first and second ends of the band align, and a mid-section of the band forms into a looped band and wherein the first and second elongated tabs are formed on the mid-section of the band at opposing positions on the looped band. The dental matrix band further comprises a third elongated tab adjacent the first elongated tab and a fourth elongated tab adjacent the second elongated tab.

### BRIEF DESCRIPTION OF THE DRAWINGS

FIG. 1 is a perspective view of an embodiment of a dental matrix band according to the present invention;

FIG. 2 is a side elevation view of the inventive dental matrix band of FIG. 1;

FIG. 3 is a front elevation view of the inventive dental matrix band of FIG. 1;

FIG. 4 is a top plan elevation view of the inventive dental matrix band of FIG. 1;

FIG. 5 is a second perspective view of the inventive dental matrix band of FIG. 1;

FIG. 6 is a perspective view of another embodiment of a dental matrix band according to the present invention;

FIG. 7 is a third perspective view of the inventive dental matrix band of FIG. 1;

FIG. 8 is a front elevation view of another embodiment of a dental matrix band according to the present invention;

FIG. 9 is a side elevation view of the inventive dental matrix band of FIG. 8;

FIG. 10 is a perspective view of the inventive dental matrix band of FIG. 8;

FIG. 11 is a top plan elevation view of the inventive dental matrix band of FIG. 8; and

FIG. 12 is another perspective view of the inventive dental matrix band of FIG. 8.

### DETAILED DESCRIPTION OF THE DRAWINGS

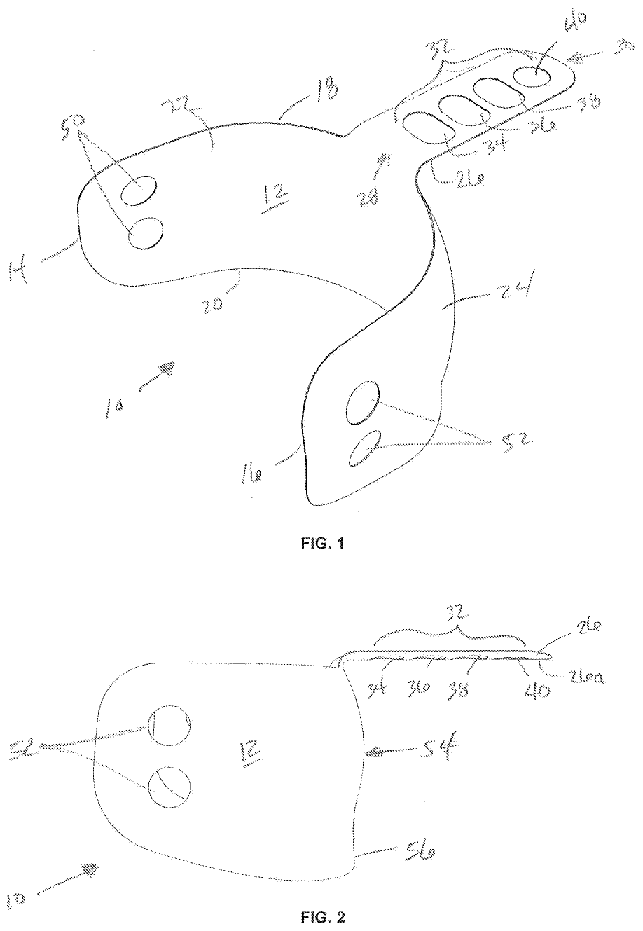

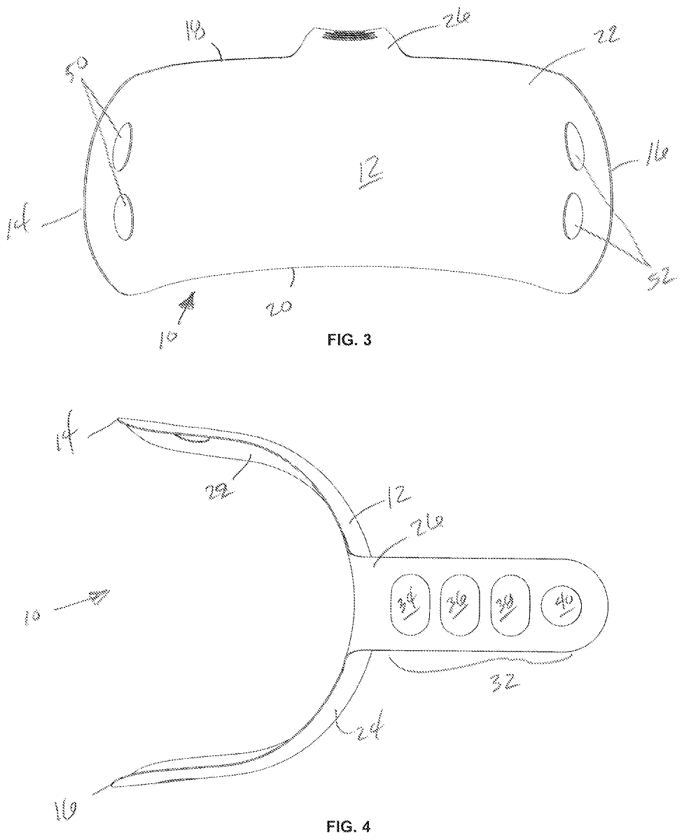

A dental matrix band comprising features of the present invention is described with reference to FIGS. 1 to 12. The invention involves the dental matrix band having a new, novel tab or plurality of tabs easily allowing a dental professional to (1) position the inventive dental matrix band, then (2) firmly pull/push the tab against the tooth adjacent tooth the tooth undergoing the restoration, and (3) stick the dental matrix band to the adjacent tooth to hold the dental matrix band in position. The inventive dental matrix band addresses the shortcomings of existing dental matrix bands and methods of use, such as sectional matrix bands that currently have a small tab in the midline between opposite ends of the band to allow pin tweezers to place the dental matrix band.

The design of the new dental matrix band shown in the appended figures makes greater use of “tab” by: (1) using at least a first extended tab; (2) including a first or a plurality of retention holes for retention when bonding to the adjacent tooth, this could be multiple holes often smaller than the main grip tab hole, (3) and can also include folds to allow easier placement or better adaptation of the dental matrix band to the adjacent tooth, and (4) with the full circumferential matrix, a plurality of tabs may be used to allow bonding to both mesial and distal adjacent teeth and also allow for multiple sizes of teeth.

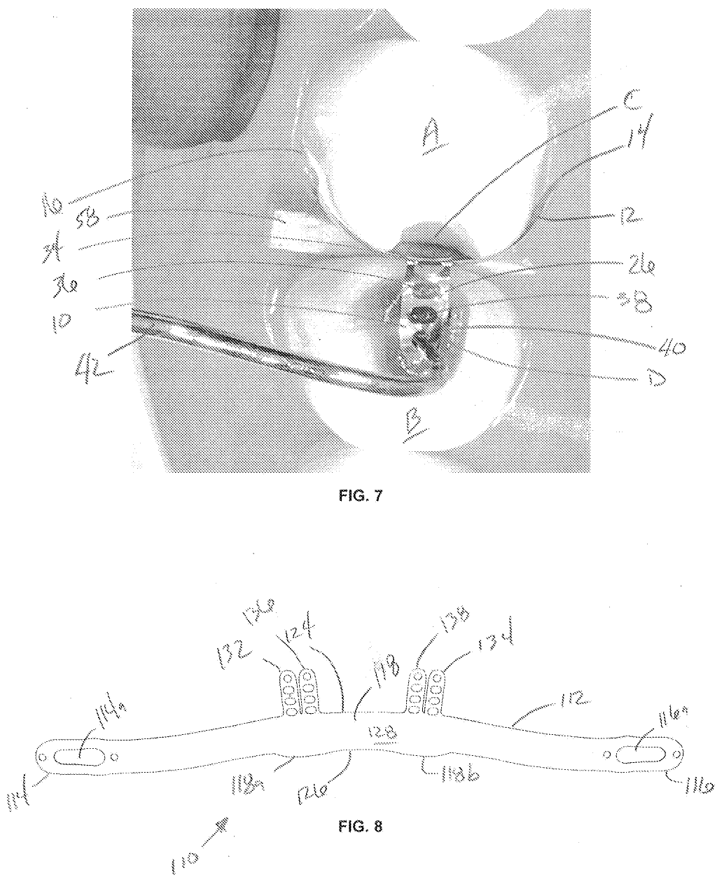

Turning first to FIGS. 1-7, a dental matrix band 10 according to the present invention is shown in the form of a sectional matrix. The dental matrix band 10 comprises a band 12 having a first and second end 14, 16, a top margin 18 and a bottom margin 20, a smooth inner surface 22 and an outer surface 24. In this figure, a first elongated tab elongated 26 extends from the top margin 18 of the band 12 and extends from a proximal end 28 at the top margin 18 to a distal end 30. The first elongated tab 26 further comprises a plurality of through holes 32 of different size and orientation. In FIGS. 1-5, the plurality of through holes 32 comprises a first retention hole 34, or, preferably, a plurality of retention holes including the first retention hole 34, a second retention hole 36, and, optionally, a third retention hole 38. The first elongated tab 26 may further comprise a first hole 40 configured to receive a dental instrument, such as a pin tweezer 42 (FIG. 7). An under-surface 26a (FIG. 2) of the elongated tab 26 may include perforations, ridges or a roughened to aid in affixation of the elongated tab to a tooth adjacent the tooth undergoing the restoration procedure.

As shown in FIG. 6, the first elongated tab 26 may also include a fold 44 dividing the first elongated tab 26 into a first, proximal section 46 and a second, distal section 48. The first and second retention holes 34, 36 are disposed in the first, proximal section 46 of the first elongated tab 26 and the first hole 38 is disposed in the second, distal section 48. This arrangement is exemplary, and it is understood that the arrangement and configuration of the dental instrument receiving hole and retention hole, or holes can vary based on need. In FIGS. 1-5, the fold (not shown) can occur between the first and second retention holes 34, 36, between the second and third retention holes 36, 38, or between the third retention hole 38 and dental instrument receiving hole 40. This flexibility is provided by the overall length of the first elongated tab 26. The fold 44 provides further flexibility and manipulability to the dental matrix band 10 by enabling fine adjustment of the tab position by a dental professional during use. As best seen in FIGS. 1 and 6, the retention holes 34, 26, 38 can be of different configurations, including, but not limited to, elongated (FIG. 1) and circular (FIG. 6).

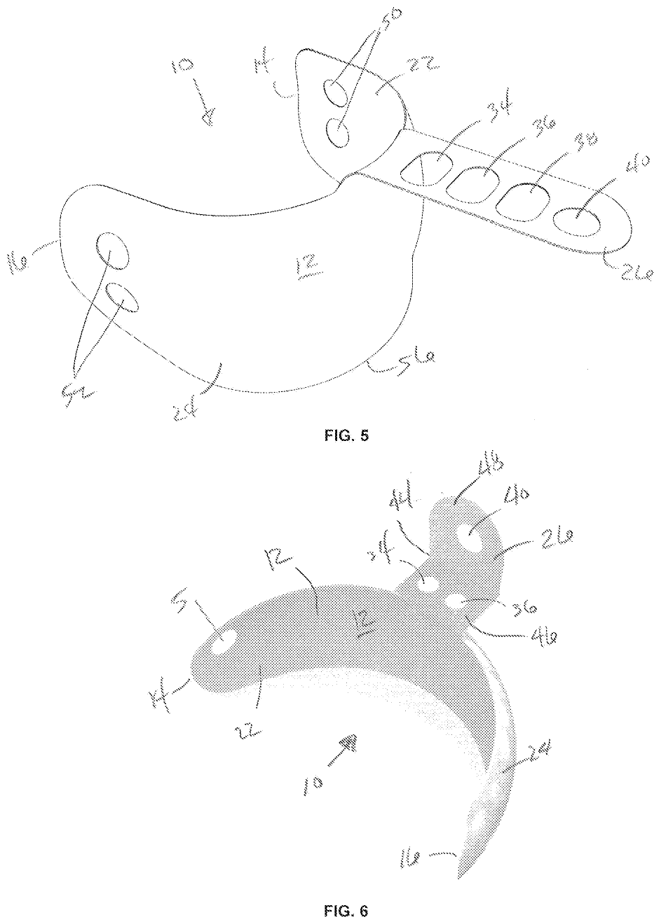

The band 12 in these figures further includes additional through holes 46, 48 at the first and second ends 14, 16. These through holes may function as retention holes or may be configured to receive a dental instrument. As a sectional matrix band, the band 12 exhibits suitable contouring between the first and second ends 14, 16 to be wrapped or formed around the tooth be restored A (FIG. 7), and suitable contouring 52 (FIG. 2) between the top margin 18 and bottom margin 20 to provide for close contact with the tooth being restored A and adjacent tooth B (FIG. 7) and ease of replication of the natural tooth anatomy at the restoration area C The band 12 further includes a flared lip 54 (FIGS. 2, 5) at the bottom margin 20 further assisting in a tight contact between the dental matrix band 10 and tooth being restored A at the gingival margin.

Turning now to FIG. 7, the inventive dental matrix band of FIGS. 1-6 is shown in use. After preparing the tooth being restored A and restoration site C, the dental professional will place the dental matrix band 10 between tooth being stored A and adjacent tooth B and wedge lower portion of the dental matrix band 10 in place against the tooth being restored A with the dental wedge 58. The dental matrix band 10 is pulled towards the adjacent tooth B using a dental instrument 42 inserts at through hole 40 until the dental matrix band 10 molds around the shape of the contact area of the adjacent tooth B. The dental matrix band 10 is held in place by bonding it to the adjacent tooth by placing a flowable light cured material such as flowable composite, which adheres the first elongated tab 26 to the adjacent tooth B. The elongated shape provides surface area necessary to securely bond the elongated tab 26 to the occlusal surface of the adjacent tooth B. The retention holes 36, 38 and perforations of the under-surface assist in the bonding process.

Additionally, the first and second ends 14, 16 of the band 12 are free to be either (1) fixed in position by such methods as placing more light curing material or using a material to wedge it into position, or (2) some dentists will find it better for making excellent seals at the edges of the margin by being able to bend it into position when uncured composite is placed.

At the conclusion of the restoration procedure after the tooth A is restored at the restoration area C, the elongated tab/tabs aid in removal of the dental matrix band 110 through normal means. The result of the restoration procedure is an excellent and consistently reproducible contact since there is no requirement for separation, and the restoration material molds to the actual neighboring tooth.

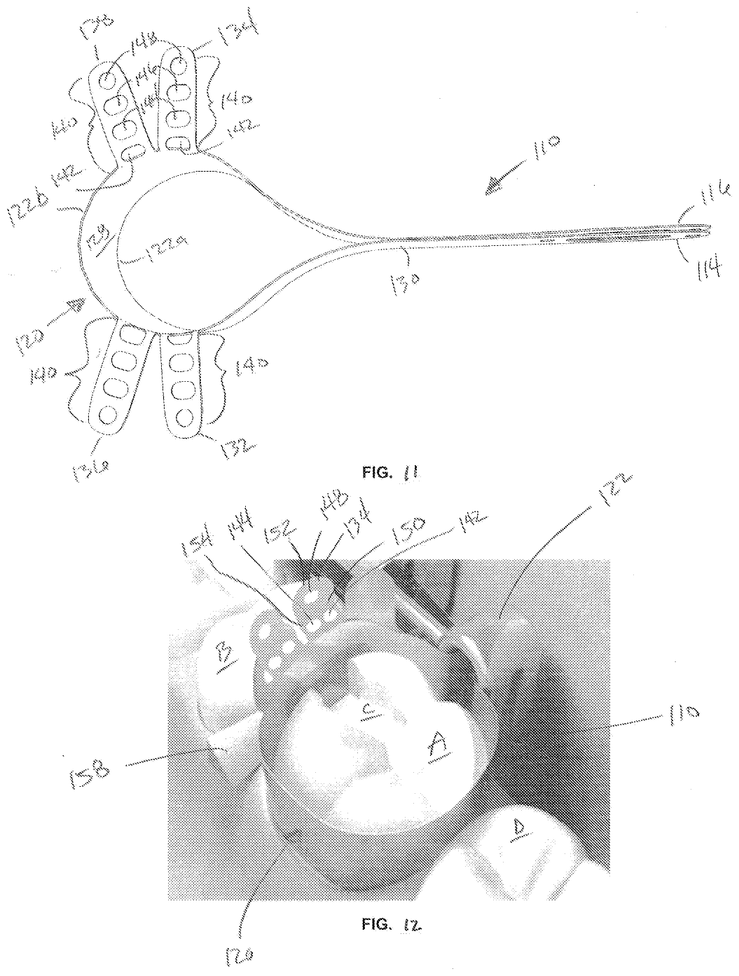

Turning next to FIGS. 8-12, a dental matrix band 110 according to the present invention is shown in the form of a circumferential matrix. The dental matrix band 110 comprises a generally elongated band 112 having a first and a second end 114, 116 and mid-section 118. One of more holes 114a, 116a are provided at each of the ends 114, 116. The band 112 is folded back on itself so that the first and second ends 114, 116 meet with the one or more holes 114a, 116a aligning and the mid-section 118 formed into a looped band 120 (FIGS. 10, 11) that wraps around the tooth being restored A (FIG. 12). The ends 114, 116 extend through a toggle 122 (FIG. 12) and are thus secured in place. As best seen in FIG. 11, the looped band 120 has a non-cylindrical shape, and is substantially conical in shape, wherein the lower portion 120a of the looped band 120 provides a smaller circumference in comparison to the upper portion 120b of the looped band 122. Adjusting the tightening device 122 will reduce or expand the circumference formed by the looped band 120.

The band 112 has a top margin 124 and a bottom margin 126 extending the length of the band, a smooth inner surface 128 and an outer surface 130. The bottom margin 126 through the mid-section 118 is contoured to include a first and second flared lip 118a, 118b to assist in tight contact between the matrix band 110 and tooth being restored during a restoration procedure. When the band 112 is formed into the looped band 120, the first and second flared lips 118a, 118b are in opposing positions on the looped band 120 to address opposite sides of the tooth being restored.

A first elongated tab 132, and preferably, at least a first and a second elongated tab 132, 134 extend from the top margin 124 of the band 112 at the mid-section 118. As seen in the appended figures, a plurality of elongated tabs 132, 134, 136, 138 extend from the top margin 124 of the band 112, with elongated tabs 132, 136 and 134, 138 grouped together at opposite ends of the mid-section 118. When the first and second ends 114, 116 are aligned to form the looped band 120, the first and second elongated tabs 132, 134 are positioned on opposing locations of the looped band 120. Likewise, the groupings of elongated tabs 132, 136 and 134, 138 are positioned on opposing locations of the looped band 120. In this arrangement, when in use the inventive dental matrix band 110 is wrapped around a tooth being restored, the elongated tabs extend over the adjacent teeth distal and mesial to the tooth being restored.

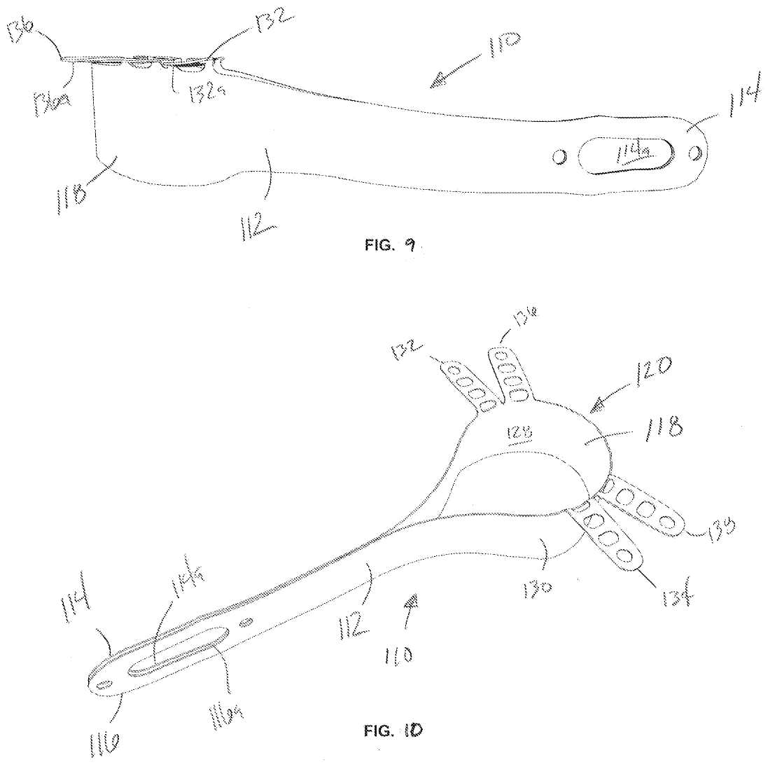

Each of the elongated tabs 132, 134, 136, 138 is shown to include a plurality of through holes 140 of different size and orientation. As best shown in FIG. 11 the plurality of through holes 140 comprises a first retention hole 142, or, preferably, a plurality of retention holes including the first retention hole 142, a second retention hole 144, and, optionally, a third retention hole 146. Each elongated tab 132, 134, 136, 138 may further comprise a first hole 148 configured to receive a dental instrument, such as a pin tweezer (not shown). Referring to FIG. 9, under-surfaces 132a, 136a of elongated tabs 132, 136 may include perforations to aid in affixation of the elongated tab to a tooth adjacent the tooth undergoing the restoration procedure.

As shown in FIG. 12, the first elongated tab 134 may also include a fold 150 dividing the first elongated tab 134 into a first, proximal section 152 and a second, distal section 154. The first and second retention holes 142, 144 are disposed in the first, proximal section 152 of the first elongated tab 134 and the first hole 148 is disposed in the second, distal section 154. This arrangement is exemplary, and it is understood that the arrangement and configuration of the dental instrument receiving hole and retention hole, or holes can vary based on need. In FIGS. 10, 11 the fold (not shown) can occur between the first and second retention holes 142, 144, between the second and third retention holes 144, 146, or between the third retention hole 146 and dental instrument receiving hole 148. This flexibility is provided by the overall length of the first elongated tab 134. The fold 150 provides further flexibility and manipulability to the dental matrix band 110 by enabling fine adjustment of the tab position by a dental professional during use. As best seen in FIGS. 11 and 12, the retention holes 142, 144, 146 can be of different configurations, including, but not limited to, elongated (FIG. 11) and circular (FIG. 12).

Referring to FIG. 12, the inventive dental matrix band 110 of FIGS. 8-11 is shown in use. After preparing the tooth being restored A and restoration site C, the dental professional will place the looped band 120 of the dental matrix band 110 around the tooth being restored A. The dental matrix band 110 may be loosened at the tightening device 122 to allow the dental matrix band 110 enough slack to be tight against the adjacent teeth A, D before bonding the first elongated tab 134, and other elongated tab being utilized, to the adjacent teeth A, D. The dental matrix band 110 is secured in place against the tooth being restored at the gingival margin with a dental wedge 158. At the conclusion of the restoration procedure after the tooth A is restored at the restoration area C, the elongated tab/tabs aid in removal of the dental matrix band 110 through normal means. The result of the restoration procedure is an excellent and consistently reproducible contact since there is no requirement for separation, and the restoration material molds to the actual neighboring tooth.

While the present invention has been described in connection with a specific application, this application is exemplary in nature and is not intended to be limiting on the possible applications of this invention. It will be understood that modifications and variations may be affected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

I claim:

1. A dental matrix band comprising:
a. a band having a first and a second end, a top margin and a bottom margin, and an inner and an outer surface,
b. a first elongated tab extending from the top margin of the band, the first elongated tab having a proximal end at the top margin and extends to a distal end, the first elongated tab comprising a plurality of through holes.

2. The dental matrix band of claim 1 wherein the plurality of through holes on the first elongated tab comprises a first hole at the distal end of the tab and at least a first retention hole at the proximal end of the tab.

3. The dental matrix band of claim 1 wherein an underside of the first elongated tab includes a bonding surface.

4. The dental matrix band of claim 3 wherein the bonding surface comprises ridges, perforations, or a roughened surface.

5. The dental matrix band of claim 1 wherein the plurality of through holes on the first elongated tab comprise a first and a second retention hole at the proximal end of the tab.

6. The dental matrix band of claim 1 wherein the first elongated tab comprises a first fold, the first fold dividing the first elongated tab into a first, proximal section and a second, distal section.

7. The dental matrix band of claim 6 wherein the first, proximal section comprises at least a first retention hole.

8. The dental matrix band of claim 6 wherein the first, proximal section and the second, distal section each comprise at least a first retention hole.

9. The dental matrix band of claim 6 wherein the second, distal section comprises a first hole configured to receive a dental tool.

10. The dental matrix band of claim 1 wherein the plurality of through holes are selected from the group comprising: retention holes, and a hole configured to receive a dental tool.

11. The dental matrix band of claim 1 wherein the dental matrix band is a sectional matrix band, and the first elongated tab is at a mid-point on the top margin between the first and second ends of the band.

12. The dental matrix band of claim 1 wherein the dental matrix band is a circumferential band, and the first elongated tab and a second tab are spaced apart along the top margin of the band.

13. The dental matrix band of claim 12 wherein the first and second tabs are spaced apart along the top margin of the band.

14. The dental matrix band of claim 13 wherein the band forms a loop and the first and second tabs are at opposing points on the loop along the top margin of the band.

15. The dental matrix band of claim 12 wherein the first and second tabs are adjacent along the top margin of the band.

16. The dental matrix band of claim 12 wherein the first and second ends of the band align, and a mid-section of the band forms into a looped band and wherein the first and second elongated tabs are formed on the mid-section of the band at opposing positions on the looped band.

17. The dental matrix band of claim 12 further comprising a third elongated tab adjacent the first elongated tab and a fourth elongated tab adjacent the second elongated tab.
